(19) United States
(12) Patent Application Publication
(10) Pub. No.: US 2021/0382139 A1
(43) Pub. Date: Dec. 9, 2021

(54) PHASE-CONJUGATING RETRODIRECTIVE CROSS-EYE RADAR JAMMING

(71) Applicant: University of Pretoria, Pretoria (ZA)

(72) Inventor: Warren Paul du Plessis, Pretoria (ZA)

(21) Appl. No.: 17/338,269

(22) Filed: Jun. 3, 2021

(30) Foreign Application Priority Data
Jun. 5, 2020 (ZA) 2020/03364

(51) Int. Cl. G01S 7/38

(52) U.S. Cl. CPC G01S 7/38

(57) ABSTRACT

An antenna array is configured for signal jamming and comprises at least two antennas each configured to receive an incoming signal and transmit a retrodirective retransmitted signal based on the incoming signal and at least two repeater components. Each one of the antennas has one of the repeater components coupled thereto. Each one of the repeater components is configured to utilize a reference signal which is common to all of the repeater components. Each one of the repeater components is configured to negate a phase of the retransmitted signal relative to the incoming signal of its coupled antenna as a function of at least the reference signal, at least one of the repeater components is further configured to introduce at least a phase adjustment to the retransmitted signal. In this way, an angular error may be induced in a threat radar.

### CROSS-REFERENCE TO RELATED APPLICATION

This application claims priority to ZA Patent Application No. 2020/03364 entitled “Phase-Conjugating Retrodirective Cross-Eye Radar Jamming”, filed on Jun. 5, 2020. The entire contents of the foregoing application is hereby incorporated by reference.

### FIELD OF INVENTION

This invention relates to radar jamming (which may have application in electronic warfare) and more specifically to a system and method for phase-conjugating retrodirective cross-eye jamming.

### BACKGROUND OF INVENTION

The Applicant has done extensive (mainly academic) research into the current state of the art relating to radar jamming and jamming or interference of reflected signals in general. Presently, this may be implemented by various types of retrodirective arrays, which are described below.

Retrodirective arrays transmit in the direction of an incoming signal as shown in FIG. 1. This retrodirective property is achieved by ensuring that the signals transmitted by repeaters connected to an array of antenna elements add in phase in the direction of the incoming signal. Two approaches to achieving this phase coherence in the direction of an incoming signal are described below.

### Van-Atta Arrays

An example of a Van-Atta retrodirective array is shown in FIGS. 2-3 [1]. The antenna elements in Van-Atta arrays are connected in pairs so that the signal received by one antenna is retransmitted by the other antenna in the pair. Additionally, all antenna pairs sharing the same midpoint as shown in FIG. 2, and the feed networks of all antenna pairs having equal phase shifts as shown in FIG. 3.

The significance of requiring a common centre point between all the pairs of antennas in a Van-Atta array is shown in FIG. 4. When rotated around a point halfway between the antennas l₁=l₂, the distance that one antenna moves closer to an incoming plane wave is equal to the distance that the other antenna in a pair moves further from an incoming plane wave l₃=l₄. The result is that the total distance the plane wave propagates to and from each pair of antenna elements is a constant because the signal received by one antenna is transmitted by the other. As long as all antenna pairs share the same centre point, an incoming plane wave will propagate identical distances to and from all the antenna pairs. In this way, the requirement that all the signals transmitted by a retrodirective array be in phase is satisfied from a propagation perspective.

Given that the propagation distances will be equal for all antenna pairs that share a common centre position, it is clear that the phase shifts through the repeaters must also be equal be to satisfy the condition for a retrodirective array. This is illustrated in FIG. 3, where all connections have the same lengths. Simply connecting antenna pairs with equal-length transmission lines is the simplest implementation of a Van-Atta array. However, additional processing and gain are normally required, and the cylinders in FIG. 3 represent the repeaters, which receive signals and re-transmit them. The total phase shift through all antenna pairs (including the antennas, transmission lines, repeaters, etc.) needs to be matched in such cases.

There is no explicit requirement that the antenna pairs be bi-directional (receive and transmit at both using antennas) or all receive and transmit on the same side of the array. A Van-Atta array will still function correctly as long as the requirements of a Van-Atta array are satisfied (all antenna pairs share a common centre point and the phase shifts through all antenna pairs, their repeater systems, and any additional components are equal), regardless of which antenna in each pair receives and whether some antenna pairs have bi-directional repeaters and some have unidirectional repeaters.

When used as a radar target, the return from a Van-Atta array appears to originate from the position at the centre of all the antenna pairs, but at a range behind that position corresponding to half the delay through each antenna pair, its repeater, and any additional components. The position that the return appears to originate from thus depends on the direction of the incoming wave. More importantly from an electronic warfare (EW) perspective, the apparent return is behind the physical location of the Van-Atta array and may even appear behind the platform mounting the Van-Atta array as shown in FIG. 5. This range separation makes it relatively simple to separate the repeater return from the return of the platform it is mounted on—a problem compounded by the fact that electromagnetic (EM) waves propagate slower in connecting components such as cables and waveguides than in air.

### Phase-Conjugating Arrays

Phase-conjugating arrays use a common reference signal to compensate the phases at the antenna elements as shown in FIGS. 6-7. The repeaters (the blocks in FIG. 7) ensure that the transmitted signal phase is the negative of the phase relative to the reference (the conjugate of the signal in phasor representation), thereby compensating for the phase shifts due to position differences relative to a phase front [2], [3].

The operating principle of a phase-conjugating array is shown in FIG. 8. The phase shifts from an arbitrary reference point on the incoming plane wave to two antennas are Ø₁ and Ø₂ at antennas 1 and 2, respectively. Transmitting signals with the negatives of these phases (−Ø₁ and −Ø₂) from the antennas will cause the transmitted signals to be phase at the plane-wave reference point because the phase shift to that plane is compensated by the phases of the signals transmitted by the repeaters at each antenna element (−Ø₁+Ø₁=−Ø₂+Ø₂). The position of the phase reference plane is irrelevant as the signals transmitted by all the repeaters at the antenna elements will add in phase on any plane perpendicular to the direction of the incoming signal. The signal received at one of the antenna elements may be used as a reference for the other repeater(s), but this is likely to be more challenging to implement than an independent reference signal. The use of a common phase reference for the signals transmitted from all antenna elements in a phase-conjugating array effectively achieves the situation depicted in FIG. 8 by substituting a common phase reference to a common phase reference plane.

The fact that phases are subject to ambiguities of integer multiples of 2π does not affect the retrodirective behaviour of a phase-conjugating array as these ambiguities do not affect the way signals add. However, these ambiguities can cause the transmitted signals to add in the direction of the incoming signal as well as in other directions. This effect is not limited to phase-conjugating arrays and occurs in all antenna arrays (including Van-Atta arrays). The techniques for reducing these sidelobes and grating lobes in retrodirective arrays are similar to the relevant techniques for conventional antenna arrays.

Phase-conjugating arrays were originally implementing by mixing the incoming signal with twice the carrier frequency because this achieves the necessary phase inversion [2], [3]. The repeaters at each antenna element would implement the relationship:

cos(ω_{c}t+Ø)cos(2ω_{c}t) (1)

cos[2ω_{c}t−(ω_{c}t+Ø)]+cos[2ω_{c}t+(ω_{c}t+Ø)] (2)

cos(ω_{c}t−Ø)+cos(3ω_{c}t+Ø) (3)

where ω_{c} is the carrier frequency, t is time, and Ø is the phase of the received signal.

The second term of the right-hand side (RHS) of (1) can easily be filtered.

Many other phase-conjugating implementations are possible depending on the implementation of the repeaters including two-stage mixing with the carrier frequency, phase-conjugating phase-locked loops (PLLs), and digital implementations [4].

### Retrodirective Cross-Eye Jamming

Analyses of glint have shown that a large angular error is induced in radar systems that receive two signals which have approximately equal amplitudes and a phase difference of approximately 180° [5]-[9]. Cross-eye jamming aims to achieve this worst-case angular error due to glint (e.g. [10]-[16]) to deceive radar systems as to the true position of a target.

The main drawback of cross-eye jamming is the miniscule range of jammer rotation angles over which a significant error is induced in a threat radar [13], [16]. As a result, retrodirective implementations of cross-eye jamming are used to ensure that the jamming signal is automatically transmitted in the direction of the incoming radar signal. The significance of the retrodirective implementation of cross-eye jamming is such that that some authors reserve the term “cross-eye jamming” for such implementations [12], [13], and the term “two-source coherent jamming” and variations thereon are often used to describe the non-retrodirective case [10], [12], [13].

### Van-Atta Cross-Eye Jammers

Retrodirective cross-eye jamming is traditionally based on the Van-Atta retrodirective implementation shown in FIG. 9 (e.g. [10]-[16]), with two patents describing such systems being filed in 1958 [17], [18]. The only change to a Van-Atta array necessary to create a retrodirective cross-eye jammer is to shift the signals in the repeater of one direction through the jammer by 180° relative to the signals in the repeater of the other direction through the jammer (i.e., a→1 and Ø→180° in FIG. 9) [17], [18]. A major advantage of this approach is that all shared aspects of the propagation path, including all the components, apart from the portions in the box in FIG. 9, are identical, so their effects cancel, thereby simplifying the practical implementation of such systems.

Only single cross-eye jammer loops, such as that shown in FIG. 9, are normally considered. The use of multiple retrodirective cross-eye jamming loops has been evaluated [19]-[21], but while promising, such multiloop retrodirective cross-eye arrays suffer from implementation challenges [22]-[24]. These challenges arise from the fact that the radar being jammed should be in the near field of the cross-eye jammer [14], so the far-field plane-wave assumption inherent in Van-Atta arrays is not valid [15], [16] (i.e. the incoming and outgoing rays are not parallel and the wavefronts are arcs in FIG. 4).

A main drawback of the use of the Van-Atta retrodirective implementation for cross-eye jamming is the delay caused by signals having to travel from one antenna to the other before retransmission. Cross-eye jammers create larger angular errors as the spacing between the jammer antennas increases, with typical antenna spacings varying from 10 to 20 m [14]. This delay will make the retrodirective cross-eye jammer return appear to be 5 to 10 m behind the positions of its antennas in even the best case.

However, transmission lines and waveguides propagate signals slower than the speed of light in air [25], practical considerations increase the required lengths of transmission lines and waveguides (e.g., FIG. 5), and any processing required in the repeaters can all further increase the delay, and thus, the apparent range of the jammer return. This apparent range offset is the motivation for using leading-edge tracking as a countermeasure to cross-eye jamming [13], even though leading-edge tracking does not directly influence the angular error induced by a cross-eye jammer.

### SUMMARY OF INVENTION

Accordingly, the invention provides an antenna array for signal jamming, the antenna array including:
at least two antennas each configured to receive an incoming signal and transmit a signal based on the incoming signal;
at least two repeater components,

wherein:
each one of the antennas has one of the repeater components coupled thereto;
each one of the repeater components is configured to utilise a common reference signal;
at least all but one of the repeater components is configured to negate a phase of the retransmitted signal relative to the incoming signal of its coupled antenna as a function of at least the reference signal to ensure that all signals are in phase at the source of the incoming signals;
at least one of the repeater components is further configured to introduce at least a phase adjustment to the retransmitted signal; and
the combined effect of the components is to cause the signals retransmitted from the antennas to phase differences of 170° to 190° and amplitude differences of less than 3 dB at the source of the incoming signal.

In a case of the antenna array having two antennas and two phase-conjugating components, only one of the repeater components may be configured to introduce the phase adjustment. The phase adjustment may be 170° to 190°, e.g., 180° (relative to what would be required for a repeater beacon). Differently stated, the signals may have a phase difference of 170° to 190° at the source of the incoming signal.

Instead, both or all repeater components may introduce the phase adjustment. The phase adjustments may be configured to cause the transmitted signals to have a phase difference of 170° to 190° at the source of the incoming signal.

At least one of the repeater components may be further configured also to introduce an amplitude adjustment to the retransmitted signal. The amplitude adjustments may be configured such that the retransmitted signals from each antenna have amplitude differences of up to 3 dM at the source of the incoming signal.

The phase adjustment (and/or the amplitude adjustment) may be to change the operation of a repeater beacon to make it a repeater cross-eye jammer by ensuring that the signals have a phase difference of 170° to 180° and an amplitude difference of less than 3 dB at the source of the incoming signal.

Respective repeater components may be coupled to one of the respective antennas only, in a one-to-one relationship.

The repeater components may also be configured to negate the phase (e.g., conjugate the signal) of the retransmitted signal as a function of an offset or phase shift. The offset or phase shift may be relative to the reference signal. As each of the repeater components utilises a common or identical reference signal, the offset or phase shift of one of the repeater components may therefore be relative to that of the other repeater components. The offset or phase shift may be 180°.

The reference signal may be provided by a signal network interconnecting the repeater components. The signal network may be phase-matched; that is, sections of the network between a signal source and each repeater component may be phase-matched. The signal network may be symmetrical, or approximately symmetrical, in that a length of the network is equal, or approximately equal, between a source of the reference signal and the respective repeater components. Conversely, it may be possible to have an asymmetrical or unequal signal network, and to compensate for the asymmetry or inequality.

While the common reference signal may be generated by one source for all of the repeater components, it could be generated from multiple sources, e.g., miniaturised and synchronised atomic clocks.

Each of the antennas may be in the form of an array of antenna components (or rather, for clarity of terminology, a sub-array of antenna components).

A benefit of a phase-conjugating cross-eye jammer is that the delay inherent in a Van-Atta cross-eye jammer (described above) is eliminated.

The invention extends to a method of operating the antenna array as defined above, the method including:
negating, by each one of the repeater components, a phase of the retransmitted signal relative to the incoming signal of its coupled antenna as a function of at least the reference signal; and
introducing, by at least one of the repeater components, at least a phase adjustment to the retransmitted signal.

### BRIEF DESCRIPTION OF DRAWINGS

The invention will now be further described, by way of example, with reference to the accompanying diagrammatic drawings.

In the drawings:

FIG. 1 illustrates a schematic view of a PRIOR ART retrodirective array transmitting signals in the direction of an incoming signal;

FIG. 2 illustrates a schematic front view of a PRIOR ART Van-Atta array showing a common centre of all antenna pairs;

FIG. 3 illustrates a schematic rear view of the Van-Atta array of FIG. 2 showing the repeater components as cylinders and the equal-length feed networks;

FIG. 4 illustrates a schematic view of a PRIOR ART rotation of a pair of antennas around its centre which does not change the total distance a retransmitted wave propagates;

FIG. 5 illustrates a schematic view of a PRIOR ART delay of a Van-Atta retrodirective array which places an apparent target behind the position of the retrodirective array (Δr), especially when antenna elements are widely spaced;

FIG. 6 illustrates a schematic front view of a PRIOR ART phase-conjugating array showing an arbitrary antenna layout;

FIG. 7 illustrates a schematic rear view of the phase-conjugating array of FIG. 6 showing the repeater components as boxes and a common reference;

FIG. 8 illustrates a schematic view of PRIOR ART operation of a phase-conjugating array showing how transmitted signals add in phase at a reference plane;

FIG. 9 illustrates a schematic view of a PRIOR ART Van-Atta retrodirective cross-eye jamming implementation;

FIG. 10 illustrates a schematic view of an antenna array, in accordance with the invention;

FIG. 11 illustrates a schematic view of geometry of the antenna array of FIG. 10 in a near field of the array;

FIG. 12 illustrates a schematic view of geometry of the antenna array of FIG. 10 interacting with monopulse radar antenna elements;

FIG. 13 illustrates a graphical representation of a simulation of a PRIOR ART Van-Atta cross-eye jammer when the radar is rotated with the jammer at a 30° angle (θ_{c}=30°);

FIG. 14 illustrates a graphical representation of the simulation of a PRIOR ART Van-Atta cross-eye jammer of FIG. 13 when the jammer is rotated with the radar pointing towards the jammer (θ_{c}=0°);

FIG. 15 illustrates a graphical representation of a simulation of the antenna array of FIG. 10 when the radar is rotated with the array at a 30° angle (θ_{c}=30°); and

FIG. 16 illustrates a graphical representation of the simulation of the antenna array of FIG. 10 when the jammer is rotated with the radar pointing towards the jammer (θ_{c}=0°).

### DETAILED DESCRIPTION OF EXAMPLE EMBODIMENT

The following description of an example embodiment of the invention is provided as an enabling teaching of the invention. Those skilled in the relevant art will recognise that changes can be made to the example embodiment described, while still attaining the beneficial results of the present invention. It will also be apparent that some of the desired benefits of the present invention can be attained by selecting some of the features of the example embodiment without utilising other features. Accordingly, those skilled in the art will recognise that modifications and adaptations to the example embodiment are possible and can even be desirable in certain circumstances and are a part of the present invention. Thus, the following description of the example embodiment is provided as illustrative of the principles of the present invention and not a limitation thereof.

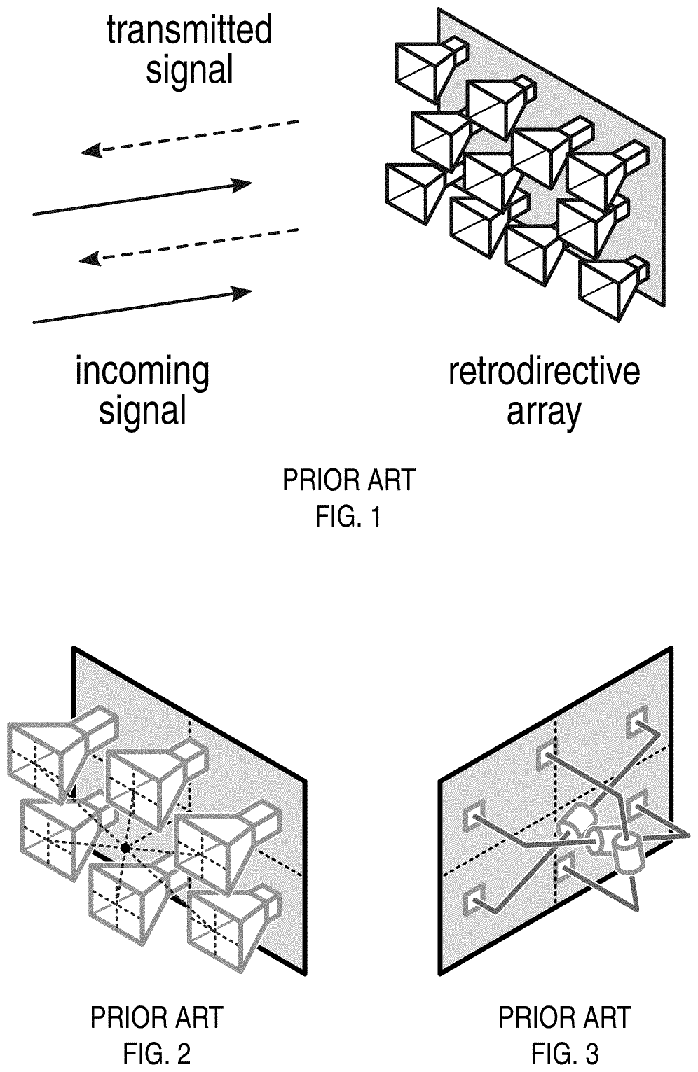

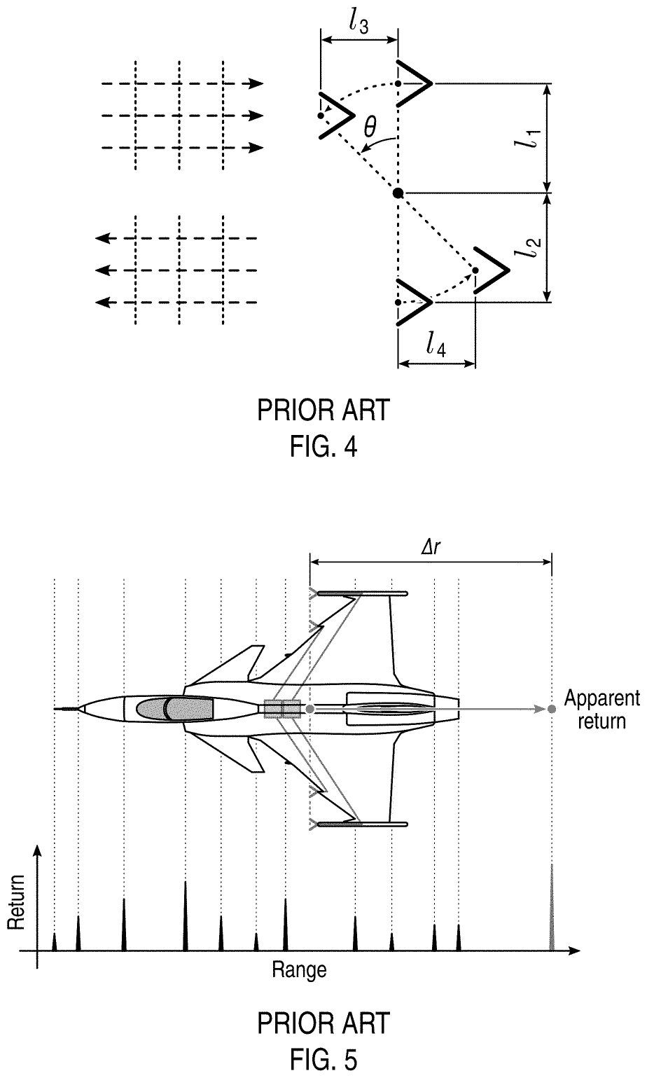

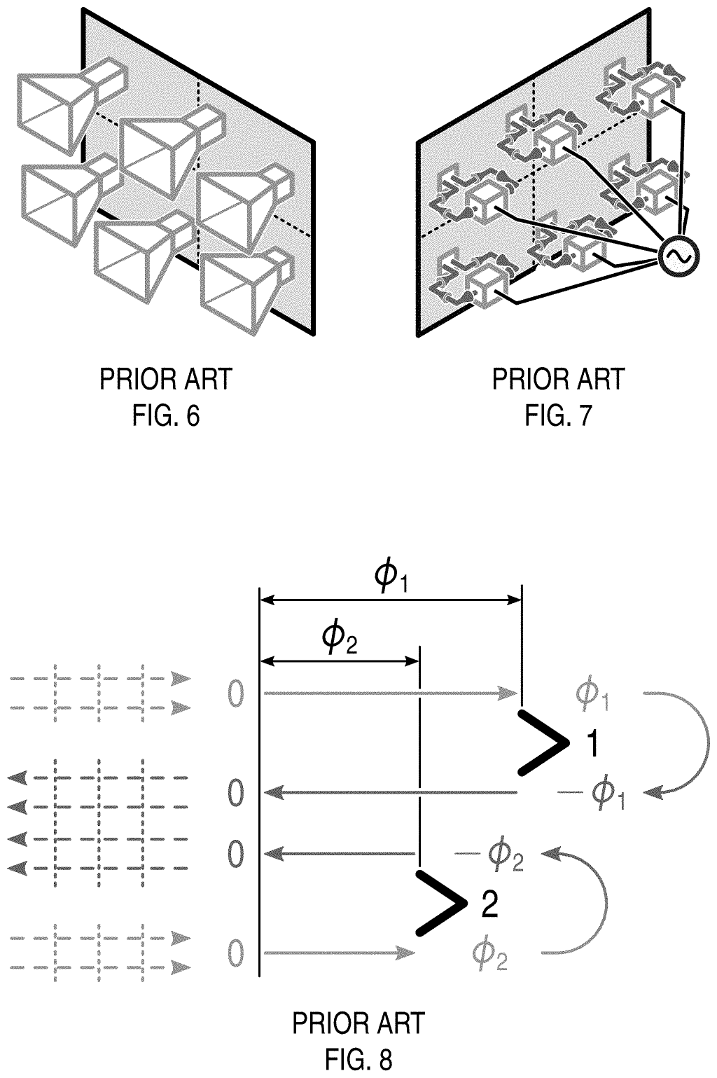

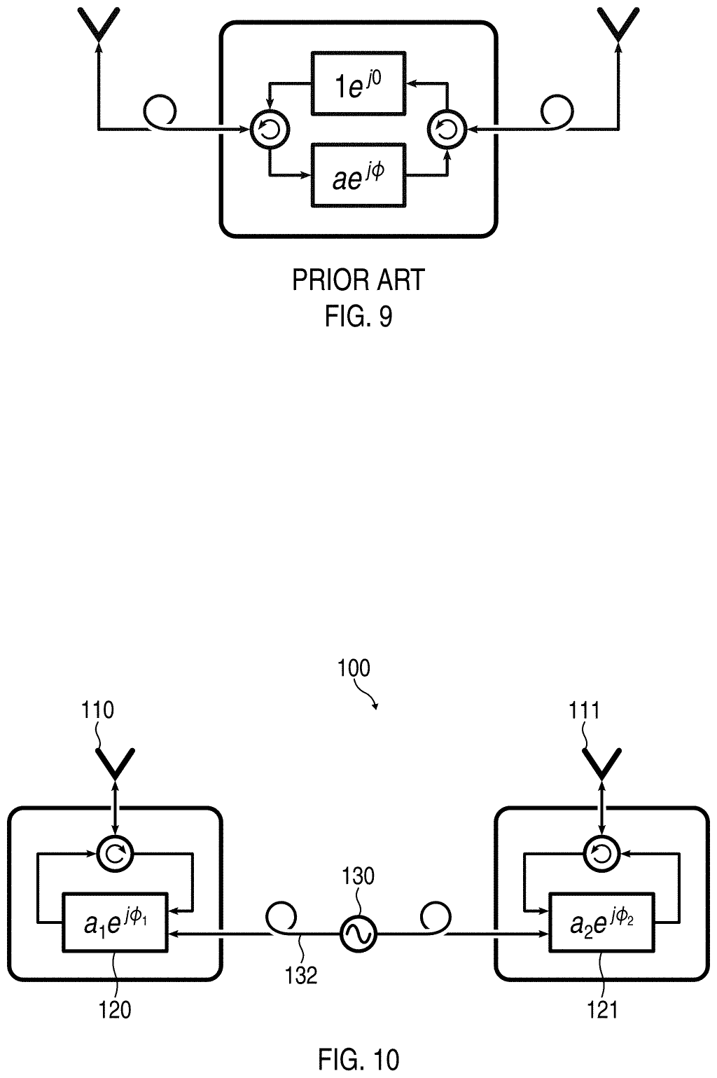

FIGS. 1-9 generally relate to prior art antenna implementations and have been described in the BACKGROUND OF INVENTION.

FIG. 10 illustrates an antenna array 100, in accordance with the invention. The antenna array 100 may be considered a phase-conjugating retrodirective cross-eye radar jamming assembly, as will become apparent from the description below.

The antenna array 100 has a pair of antennas 110, 111 which may be the simplest implementation. An antenna array with more than two antennas may also be practicable using the teachings of this invention; a version with more than two antennas may even be advantageous or desirable compared to the simplest two-antenna implementation. The antennas 110, 111 are each configured to receive an incoming signal and transmit a retrodirective retransmitted signal based, at least partially, on the incoming signal.

Each antenna 110, 111 has connected thereto a repeater circuit component 120, 121. Respective repeater components 120, 121 are coupled to respective antennas 110, 111 in a one-to-one relationship. In other words, each antenna 110, 111 has only one repeater component 120, 121 associated therewith. Further, that repeater component 120, 121 is uniquely associated with that antenna 110, 111. The repeater components 120, 121 are configured to conjugate a phase of the retransmitted signal relative to the incoming signal of its coupled antenna 110, 111.

The antenna array 100 has a signal network 132 configured to provide a reference signal 130 to the repeater components 120, 121. Each of the repeater components 120, 121 receives the same reference signal 130 and it is therefore a common reference signal 130. Sections of the signal network 132 between a signal source (e.g., an oscillator) and the repeater components 120, 121 are phase-matched so that the same reference signal 130 is provided to each of the repeater components 120, 121.

In this example embodiment, the repeater components 120, 121 are configured to generate the retransmitted signal based on the incoming signal and two additional factors: the reference signal 130 and internal phase criteria specific to each repeater component 120, 121. The phase criteria may specify, for example, that the phases of the retransmitted signals produced by the repeater components 120, 121 are different, e.g., out of phase, e.g., by 180°. An amplitude may also be varied.

As a result of the fact that the antenna array 100, being a repeater retrodirective cross-eye jammer, is new, no mathematical analysis of this case exists. Accordingly, the Inventor has conducted an extensive mathematical analysis of such an antenna array 100. While it may be assumed that the far-field analysis for retrodirective arrays provided above can be reused, this is actually not the case, because the antenna array 100 must operate in its near field to be effective [14], so the far-field analysis cannot be reused. A mathematical analysis of the case where a phase-conjugating array is not operating in its far-field region is thus provided below.

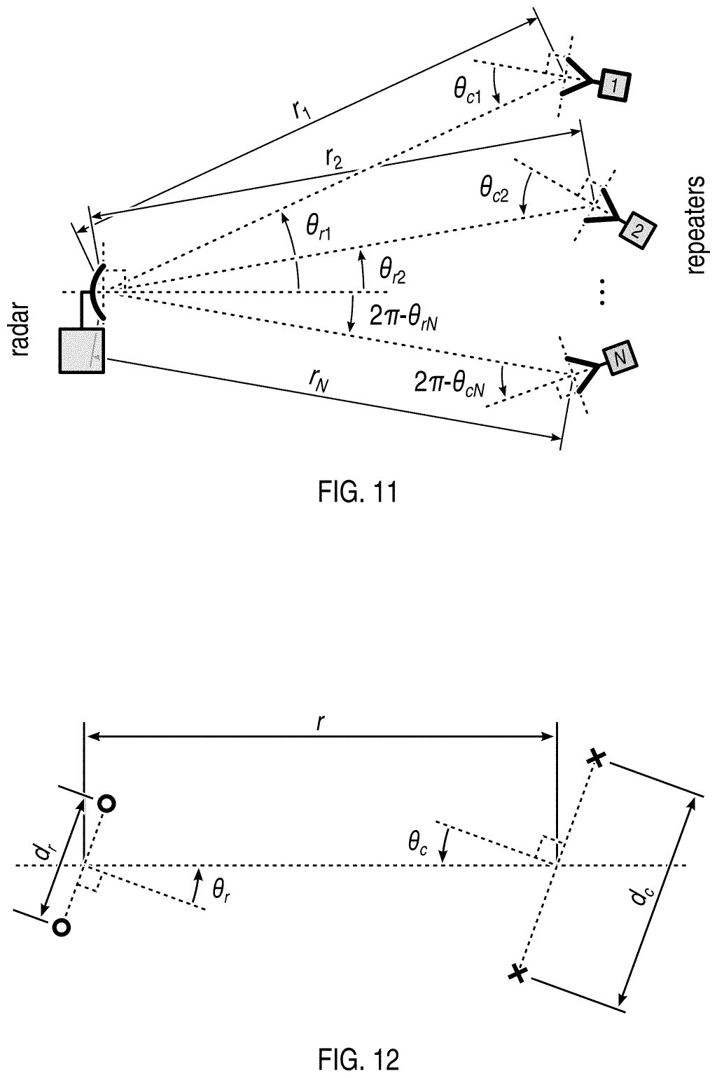

Starting with an analysis of a retrodirective phase-conjugating array, and then moving to a cross-eye jammer, an electric field Eₜ relative to a phase reference Ø_{z} at a radar from a number of repeaters in the far field of the radar is given by

$$\begin{matrix}{E}_{t} ∝ {\sum }_{n = 1}^{N} {[ {P}_{r} ( {θ}_{rn} ) {P}_{c} ( {θ}_{cn} ) ]}^{2} {E}_{rn} & ( 4 ) \\ ∝ {\sum }_{n = 1}^{N} {[ {P}_{r} ( {θ}_{rn} ) {P}_{c} ( {θ}_{cn} ) ]}^{2} \frac{{a}_{n} {e}^{j ( 2 β {r}_{n} + {Ø}_{n} - {Ø}_{z} )}}{{r}_{n}^{4}} & ( 5 )\end{matrix}$$

where β is the free-space propagation constant, N is the number of repeaters, and a subscript n denotes repeater n. The parameters for each repeater are the radar and repeater antenna gains Pᵣ(θᵣₙ) and P_{c}(θ_{cn}) at angles θₘ and θ_{cn} shown in FIG. 11, the electric field Eᵣₙ, the gain and phase shift aₙ and Øₙ, and the range rₙ shown in FIG. 11.

Ensuring that the signals from a number of repeaters add in phase at the radar (the goal of a retrodirective array) requires that Øₙ=−2βrₙ to ensure that all signals are received in phase. However, achieving this objective may be impractical as the range to each repeater is not precisely known.

Explicitly accounting for the 2π ambiguity of phase gives

$$\begin{matrix}{E}_{t} ∝ {\sum }_{n = 1}^{N} \frac{{a}_{n} {e}^{j ( 2 β {r}_{n} + {Ø}_{n} )}}{{r}_{n}^{4}} {e}^{- j {Ø}_{z}} {e}^{j 2 π 2 {m}_{n}} & ( 6 ) \\ ∝ {\sum }_{n = 1}^{N} \frac{{a}_{n}}{{r}_{n}^{4}} {e}^{j ( β {r}_{n} + {Ø}_{n} - {Ø}_{z} + 2 π 2 {m}_{n} )} & ( 7 ) \\ ∝ {\sum }_{n = 1}^{N} \frac{{e}^{j ( β {r}_{n} + 2 π {m}_{n} - {Ø}_{z} )}}{{r}_{n}^{2}} {a}_{n} {e}^{j {Ø}_{n}} \frac{{e}^{j ( β {r}_{n} + 2 π {m}_{n} )}}{{r}_{n}^{2}} & ( 8 )\end{matrix}$$

where mₙ are integers. The three factors in the summation in (8) correspond to the influence of the path from the radar to repeater n relative to a phase reference, the effect of the repeater, and the influence of the path from the repeater back to the radar, respectively.

The conjugation of the signal at the repeater means the signal transmitted by each repeater, Eₛₙ must be

$$\begin{matrix}{E}_{sn} ∝ [ \frac{{e}^{j ( β {r}_{n} + 2 π {m}_{n} - {Ø}_{z} )}}{{r}_{n}^{2}} ] & ( 9 ) \\ ∝ \frac{{e}^{- j ( β {r}_{n} + 2 π {m}_{n} - {Ø}_{z} )}}{{r}_{n}^{2}} & ( 10 ) \\ ∝ \frac{{e}^{j ( β {r}_{n} + 2 π {m}_{n} - {Ø}_{z} )}}{{r}_{n}^{2}} {e}^{- j 2 ( β {r}_{n} + 2 π {m}_{n} - {Ø}_{z} )} . & ( 10 )\end{matrix}$$

This result corresponds to setting the repeater phase shift in (8) to

Øₙ=−2(βrₙ+2πmₙ−Ø_{z}) (12)

which leads to

$$\begin{matrix}{E}_{t} ∝ {\sum }_{n = 1}^{N} \frac{{e}^{j ( β {r}_{n} + 2 π {m}_{n} - {Ø}_{z} )}}{{r}_{n}^{2}} {a}_{n} {e}^{- j 2 ( β {r}_{n} + 2 π {m}_{n} - {Ø}_{z} )} \times \frac{{e}^{j ( β {r}_{n} + 2 π {m}_{n} )}}{{r}_{n}^{2}} & ( 13 ) \\ ∝ {\sum }_{n = 1}^{N} \frac{{e}^{- j ( β {r}_{n} + 2 π {m}_{n} - {Ø}_{z} )}}{{r}_{n}^{2}} {a}_{n} \frac{{e}^{j ( β {r}_{n} + 2 π {m}_{n} )}}{{r}_{n}^{2}} & ( 14 ) \\ ∝ {\sum }_{n = 1}^{N} {e}^{j {Ø}_{z}} \frac{{a}_{n}}{{r}_{n}^{4}} & ( 15 ) \\ ∝ {e}^{j {Ø}_{z}} {\sum }_{n = 1}^{N} \frac{{a}_{n}}{{r}_{n}^{4}} & ( 16 )\end{matrix}$$

which has all the repeater phases equal, as required for a retrodirective array.

An important observation from an implementation perspective is that the phase reference Ø_{z} is arbitrary, so the only requirement is that it be the same for all repeaters. The implementation in FIG. 10 achieves a common phase by sharing the reference signal 130 from a common oscillator to all jammer channels via phase-matched cables of the signal network 132. However, synchronisation by other means or the use of miniaturised atomic clocks is also possible and opens the possibility of using multiple platforms to implement cross-eye jamming.

Considering two repeaters and modifying (12) to

Øₙ=−2(βrₙ+2πmₙ−Ø_{z})+Øₒₙ (17)

where Øₒₙ is a phase offset, changes (16) to

$$\begin{matrix}{E}_{t} ∝ {e}^{j {Ø}_{z}} {\sum }_{n = 1}^{2} \frac{{a}_{n}}{{r}_{n}^{4}} {e}^{j {Ø}_{on}} & ( 18 ) \\ ∝ {e}^{j {Ø}_{z}} [ \frac{{a}_{1}}{{r}_{1}^{4}} {e}^{j {Ø}_{o 1}} + \frac{{a}_{2}}{{r}_{2}^{4}} {e}^{j {Ø}_{o 2}} ] & ( 19 ) \\ ∝ \frac{{a}_{1}}{{r}_{1}^{4}} {e}^{j ( {Ø}_{z} - {Ø}_{o 1} )} [ 1 + \frac{{a}_{2} {r}_{1}^{4}}{{a}_{1} {r}_{2}^{4}} {e}^{j ( {Ø}_{o 2} - {Ø}_{o 1} )} ] & ( 20 ) \\ {E}_{t} \frac{{r}_{1}^{4}}{{a}_{1}} {e}^{j ( {Ø}_{o 1} - {Ø}_{z} )} ∝ 1 + \frac{{a}_{2} {r}_{1}^{4}}{{a}_{1} {r}_{2}^{4}} {e}^{j ( {Ø}_{o 2} - {Ø}_{o 1} )} & ( 21 ) \\ {E}_{t} \frac{{r}_{1}^{4}}{{a}_{1}} {e}^{j ( {Ø}_{o 1} - {Ø}_{z} )} ∝ 1 + {ae}^{j Ø} & ( 22 )\end{matrix}$$

where a=a₂ r₁⁴/a₁r₂⁴ and Ø=Øₒ₂−Øₒ₁. Letting a→1 and Ø→180° gives two signals of approximately equal amplitudes and a phase difference of 180°, thereby achieving the conditions required for cross-eye jamming.

### Simulations

The following parameters of a cross-eye jamming engagement are used to simulate a representative missile threat against an aircraft or ship [15], [16], [22], [26]:
10 GHz frequency,
1 km engagement range (r=1 000 m),
10 m jammer baseline (d_{c}=10 m),
2.54 wavelength separation of the radar antenna elements (dᵣ=2.542) to give a radar sum-channel beamwidth of approximately 10°,
30° jammer-rotation difference (θ_{c}=30°),
jammer-amplitude match of 0.5 dB (aₙ=0.9441), and
jammer phase difference of 175° (ϕₙ=175°).

The relevant geometry is shown in FIG. 12, with monopulse radar antenna elements on the left denoted by circles and the antennas 110, 111 on the right denoted by crosses.

The simulations were performed with the nec2c version 1.3 implementation of the Numerical Electromagnetics Code (NEC) [27] using horizontal dipoles of length 0.4860 wavelengths with 21 segments to model the phase-comparison monopulse antenna elements and the jammer antennas. Horizontal dipoles were used as to minimise the coupling as end-on dipoles have low coupling [28], and the length was chosen to minimise the imaginary component of the input impedance. A first simulation was performed with the two radar dipoles were excited with 1 V sources at their centre segments, and the voltages at centre segments of the jammer dipoles were determined. A second simulation was then performed with voltages at the centre segments of the jammer antennas set to values corresponding to the jammer transmission signals, and the voltages at the centre segments of the radar dipoles were determined. These voltages at the two radar dipoles were then combined to form the sum- and difference-pattern returns, after which monopulse processing was performed.

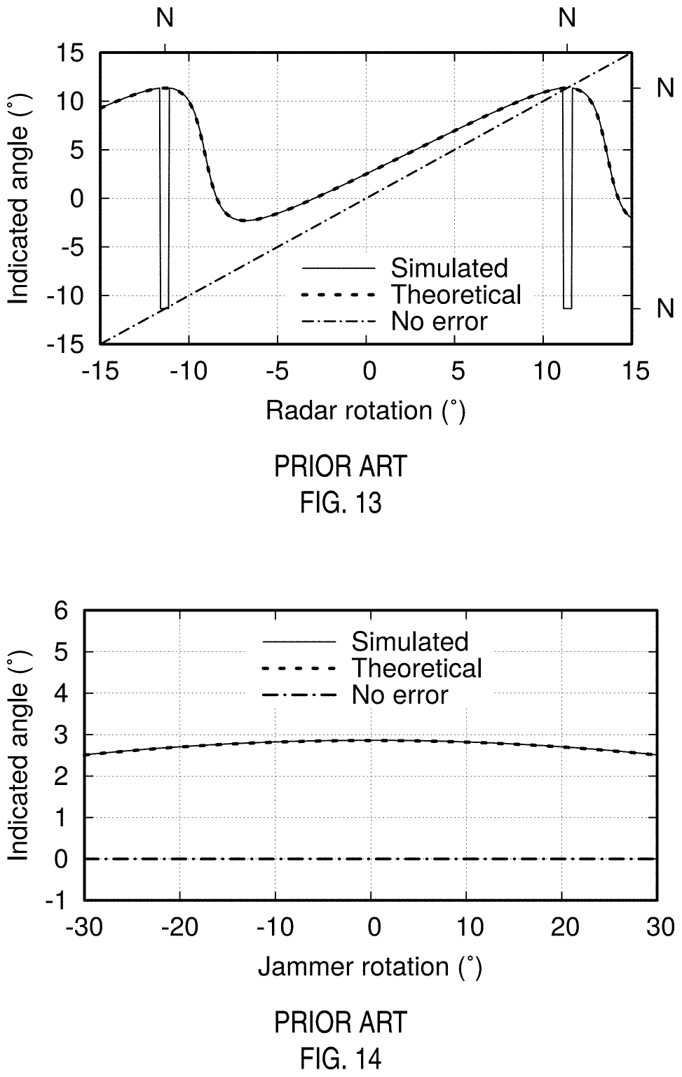

The first set of simulations serve to validate this approach by considering a Van-Atta cross-eye jammer. The simulated monopulse indicated angles are compared to theoretical results which have been experimentally validated [15], [16], [29] in FIGS. 13-14. FIGS. 13-14 illustrate an indicated angle induced in a radar by a Van-Atta cross-eye jammer, where letters “N” on the top and right axes indicate positions of the first sum-channel nulls. The agreement between the simulated and validated theoretical results is almost perfect, thereby confirming that the above approach to using NEC-2 to simulate cross-eye jammers is valid.

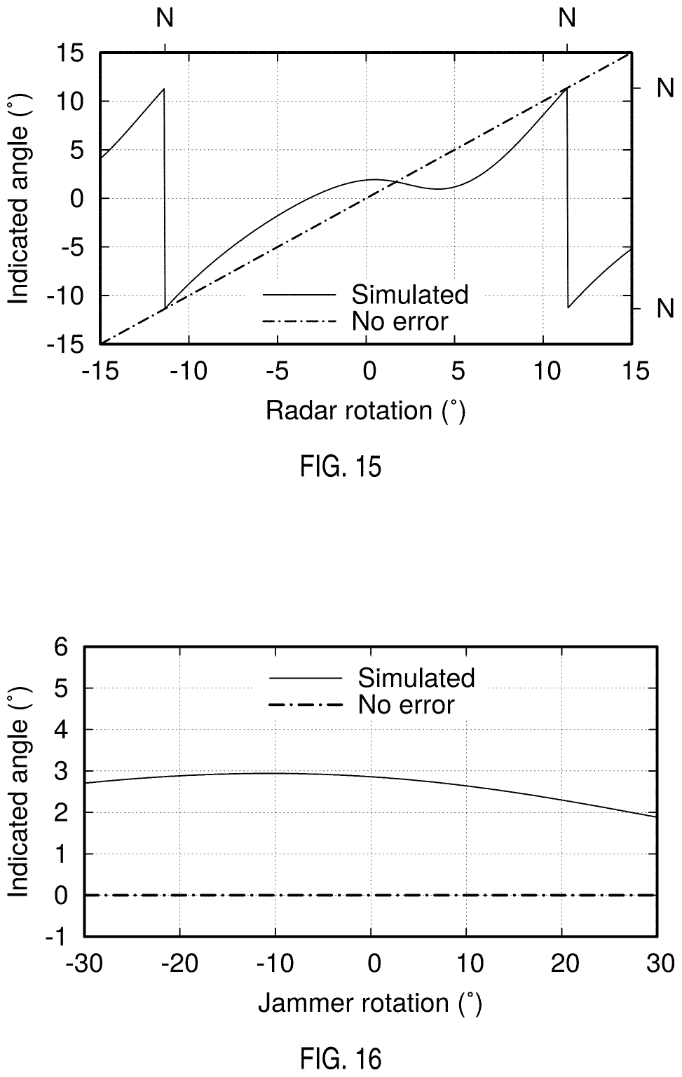

The second set of results considers a phase-conjugating cross-eye jammer, and the results are shown in FIGS. 15-16. FIGS. 15-16 illustrate an indicated angle induced in a radar by the antenna array 100, where letters “N” on the top and right axes indicate positions of the first sum-channel nulls. FIG. 15 shows that a large indicated angle error is obtained for all radar rotations, thereby demonstrating the ability of phase-conjugating cross-eye jammer to cause large angular errors. More importantly, FIG. 16 shows that the indicated angle, which should be zero, remains high over the wide range of jammer rotations considered. FIG. 16 thus demonstrates that a phase-conjugating has retrodirective properties because the jammer rotation does not have a significant influence on the resulting angular error.

The asymmetry and non-monotonic variations in FIGS. 15-16 for the phase-conjugating cross-eye jammer are believed to be due to the fact that the signals to each of the jammer antennas travel different distances and thus experience different path losses. This effect cannot occur in a Van-Atta cross-eye jammer as both signals travel along identical paths, just in different directions, so the path losses are equal. Accordingly, the Applicant believes that the disclosure provides an effective cross-eye jammer based on phase-conjugating retrodirective arrays.

### REFERENCES

[1] U.S. Pat. No. 2,908,002.
[2] C. C. Cutler, R. Kompfner, and L. C. Tillotson, “A self-steering array repeater,” Bell Syst. Tech. J., vol. 42, no. 5, pp. 2013-2032, September 1963.
[3] C. Y. Pon, “Retrodirective array using the heterodyne technique,” IEEE Trans. Aerosp. Electron. Syst., vol. 12, no. 2, pp. 176-180, March 1964.
[4] V. Fusco and N. Buchanan, “Developments in retrodirective array technology,” IET Microw. Antennas Propag., vol. 7, no. 2, pp. 131-140, January 2013.
[5] D. D. Howard, “Radar target angular scintillation in tracking and guidance systems based on echo signal phase front distortion,” in Proc. Nat. Eng. Conf., vol. 15, 1959, reprinted in Radars, Vol. 4, Radar Resolution & Multipath Effects, David K. Barton, Ed., Artech House, 1975.
[6] J. H. Dunn and D. D. Howard, “Radar target amplitude, angle, and doppler scintillation from analysis of the echo signal propagating in space,” IEEE Trans. Microw. Theory Tech., vol. 9, no. 9, pp. 715-728, September 1968.
[7] J. E. Lindsay, “Angular glint and the moving, rotating, complex radar target,” IEEE Trans. Aerosp. Electron. Syst., vol. 4, no. 2, pp. 164-173, March 1968.
[8] S. M. Sherman and D. K. Barton, Monopulse principles and techniques, 2nd ed. Artech House, 2011.
[9] J. W. Wright, “Radar glint—a survey,” Electromagnetics, vol. 4, no. 2, pp. 205-227, January 1984.
[10] S. A. Vakin and L. N. Shustov, “Principles of jamming and electronic reconnaissance—Volume I,” U.S. Air Force, Tech. Rep. FTD-MT-24-115-69, AD692642, 1969.
[11] L. B. Van Brunt, Applied ECM. EW Engineering, Inc., 1978, vol. 1.
[12] A. Golden, Radar Electronic Warfare. AIAA Inc., 1987.
[13] D. C. Schleher, Electronic warfare in the information age. Artech House, 1999.
[14] L. Falk, “Cross-eye jamming of monopulse radar,” in IEEE Waveform Diversity & Design Conf., Pisa, Italy, 4-8 Jun. 2007, pp. 209-213.
[15] W. P. du Plessis, J. W. Odendaal, and J. Joubert, “Extended analysis of retrodirective cross-eye jamming,” IEEE Trans. Antennas Propag., vol. 57, no. 9, pp. 2803-2806, September 2009.
[16] W. P. du Plessis, “A comprehensive investigation of retrodirective cross-eye jamming,” Ph.D. dissertation, University of Pretoria, 2010.
[17] U.S. Pat. No. 4,117,484.
[18] U.S. Pat. No. 4,006,478.
[19] W. P. du Plessis, “Cross-eye gain in multi-loop retrodirective cross-eye jamming,” IEEE Trans. Aerosp. Electron. Syst., vol. 52, no. 2, pp. 875-882, April 2016.
[20] T. Liu, D. Liao, X. Wei, and L. Li, “Performance analysis of multiple-element retrodirective crosseye jamming based on linear array,” IEEE Trans. Aerosp. Electron. Syst., vol. 51, no. 3, pp. 1867-1876, July 2015.
[21] S. Liu, C. Dong, J. Xu, G. Zhao, and Y. Zhu, “Analysis of rotating cross-eye jamming,” IEEE Antennas Wireless Propag. Lett., vol. 14, pp. 939-942, December 2015.
[22] W. P. du Plessis, “Path-length effects in multiloop retrodirective cross-eye jamming,” IEEE Antennas Wireless Propag. Lett., vol. 15, pp. 626-629, March 2016.
[23] W. P. du Plessis, “Analysis of path-length effects in multi-loop cross-eye jamming,” IEEE Trans. Aerosp. Electron. Syst., vol. 53, no. 5, pp. 2266-2276, October 2017.
[24] W. P. du Plessis, “Path-length compensation in multi-loop retrodirective cross-eye jamming,” IEEE Trans. Aerosp. Electron. Syst., vol. 55, no. 1, pp. 397-406, February 2019.
[25] D. M. Pozar, Microwave Engineering, 2nd ed. John Wiley & Sons, Inc., 1998.
[26] W. P. du Plessis, “Phase-conjugating retrodirective cross-eye jamming,” Electron. Lett., vol. 56, no. 20, pp. 1079-1082, 20 Sep. 2020.
[27] N. Kyriazis. (2020, 27 Jan.) Ham radio station 5B4AZ. [Online]. Available: http://www.5b4az.org/[28]
[28] W. L. Stutzman and G. A. Thiele, Antenna theory and design, 2nd ed. John Wiley & Sons, Inc., 1998.
[29] W. P. du Plessis, J. W. Odendaal, and J. Joubert, “Experimental simulation of retrodirective crosseye jamming,” IEEE Trans. Aerosp. Electron. Syst., vol. 47, no. 1, pp. 734-740, January 2011.

1. An antenna array configured for signal jamming, the antenna array comprising:
at least two antennas each configured to receive an incoming signal and transmit a signal based on the incoming signal; and
at least two repeater components, wherein:
each one of the antennas has one of the repeater components coupled thereto;
each one of the repeater components is configured to utilize a reference signal which is common to all of the repeater components;
at least all but one of the repeater components is configured to modify a phase of the retransmitted signal relative to the incoming signal of its coupled antenna as a function of at least the reference signal;
at least one of the repeater components is further configured to introduce at least a phase adjustment to the retransmitted signal; and
the combined effect of the components is to cause the signals retransmitted from the antennas to phase differences of 170° to 190° and amplitude differences of less than 3 dB at the source of the incoming signal.

2. The antenna array as claimed in claim 1, which includes only two antennas and two repeater components, wherein only one of the repeater components is configured to introduce the phase adjustment.

3. The antenna array as claimed in claim 2, wherein the phase adjustment is 170° to 190°.

4. The antenna array as claimed in claim 1, wherein all of the repeater components introduce the phase adjustment.

5. The antenna array as claimed in claim 4, wherein the phase adjustment is such that the retransmitted signal has a phase difference of 170° to 190° at the source of the incoming signal.

6. The antenna array as claimed in claim 1, wherein at least one of the repeater components is further configured to introduce an amplitude adjustment to the retransmitted signal.

7. The antenna array as claimed in claim 6, wherein the amplitude adjustment is such that the retransmitted signals from each antenna have amplitude differences of up to 3 dB at the source of the incoming signal.

8. The antenna array as claimed in claim 1, wherein the phase adjustment is configured to change the operation of a repeater beacon to make it a repeater cross-eye jammer by ensuring that the signals have a phase difference of 170° to 180° and an amplitude difference of less than 3 dB at the source of the incoming signal.

9. The antenna array as claimed in claim 1, wherein respective repeater components are coupled to one of the respective antennas only, in a one-to-one relationship.

10. The antenna array as claimed in claim 1, wherein the repeater components are configured to negate the phase of the retransmitted signal also as a function of an offset or phase shift.

11. The antenna array as claimed in claim 10, wherein the offset or phase shift is relative to the reference signal.

12. The antenna array as claimed in claim 10, wherein the offset or phase shift of one of the repeater components is relative to that of one of the other repeater components as all of the repeater components utilize the reference signal.

13. The antenna array as claimed in claim 1, wherein the reference signal is provided by a signal network interconnecting the repeater components.

14. The antenna array as claimed in claim 13, in which the signal network is phase-matched.

15. The antenna array as claimed in claim 14, in which the signal network is symmetrical in that a length of the network is equal between a source of the reference signal and the respective repeater components.

16. The antenna array as claimed in claim 1, in which either:
the reference signal is generated by one source for all of the repeater components; or
the reference signal is generated by multiple synchronized sources.

17. The antenna array as claimed in claim 1, in which each of the antennas is in the form of a sub-array of antenna components.

18. A method of operating the antenna array as claimed in claim 1, the method comprising:
negating, by each one of the repeater components, a phase of the retransmitted signal relative to the incoming signal of its coupled antenna as a function of at least the reference signal; and
introducing, by at least one of the repeater components, at least a phase adjustment to the retransmitted signal.
